(19) United States
(12) Patent Application Publication
(10) Pub. No.: US 2020/0021772 A1
(43) Pub. Date: Jan. 16, 2020

(54) MULTIMEDIA RECORDING DATA OBTAINING METHOD AND TERMINAL DEVICE

(71) Applicant: UBTECH Robotics Corp, Shenzhen (CN)

(72) Inventors: Youjun Xiong, Shenzhen (CN); Yuchao Pan, Shenzhen (CN)

(21) Appl. No.: 16/355,873

(22) Filed: Mar. 18, 2019

(30) Foreign Application Priority Data
Jul. 10, 2018 (CN) 201810750357.X

(51) Int. Cl. H04N 5/91; G06F 9/48; G06F 9/38

(52) U.S. Cl. CPC H04N 5/91; G06F 9/3855; G06F 9/485

(57) ABSTRACT

The present disclosure provides a multimedia recording data obtaining method and terminal device. The method includes: creating a first service recording thread upon receiving a recording request of a first application program of a terminal device; obtaining first multimedia data recorded by a multimedia recording device of the terminal device through the first service recording thread, returning the first multimedia data to the first application program, and storing the first multimedia data to a first storage space; creating a second service recording thread corresponding to a second application program of the terminal device if a recording request of the second application program is received when the first service recording thread is executing; and obtaining, by the second application program, the first multimedia data from the first storage space through the second service recording thread.

### CROSS REFERENCE TO RELATED APPLICATION PROGRAMS

This application claims priority to Chinese Patent Application No. CN201810750357.X, filed Jul. 10, 2018, which is hereby incorporated by reference herein as if set forth in its entirety.

### BACKGROUND

### 1. Technical Field

The present disclosure relates to multimedia recording technology, and particularly to a multimedia recording data obtaining method and terminal device.

### 2. Description of Related Art

The existing operating systems for terminal devices such as mobile phones allow only one application to perform multimedia recording at a time. For example, in a terminal device, a recording device on the terminal device, for example, a microphone, can only be occupied by one recording thread in the terminal device at a time. When an application in the terminal device is recording, if another application in the terminal device also requirements to record, the system of the terminal device will not allow the recording request from the another application. At present, the existing terminal device only allows one application to perform multimedia recording at a time, which cannot meet the requirement that multiple application programs perform multimedia recording simultaneously and causes inconvenience in use.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a flow chart of an embodiment of a multimedia recording data obtaining method according to present disclosure.

FIG. 2 is a schematic diagram of an example of an ANDROID system for implementing the multimedia recording data obtaining method of FIG. 1.

FIG. 3 is a flow chart of performing a resampling process on the first multimedia data in the multimedia recording data obtaining method of FIG. 1.

FIG. 4 is a flow chart of another embodiment of a multimedia recording data obtaining method according to present disclosure.

FIG. 5 is a schematic diagram of an example of an ANDROID system for implementing the multimedia recording data obtaining method of FIG. 4.

FIG. 6 is a schematic block diagram of a multimedia recording data obtaining apparatus according to an embodiment of present disclosure.

FIG. 7 is a schematic block diagram of a terminal device according to an embodiment of present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

For the purpose of describing the technical solutions of the present disclosure, the following describes through specific embodiments.

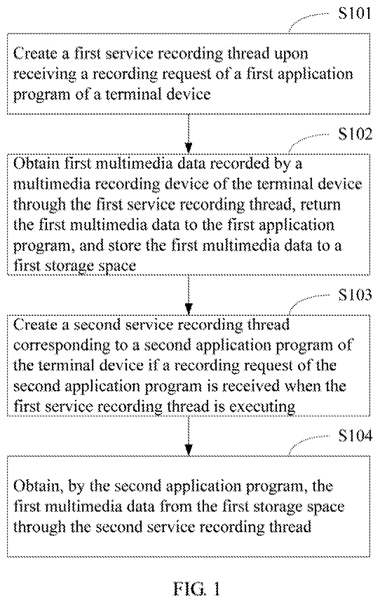

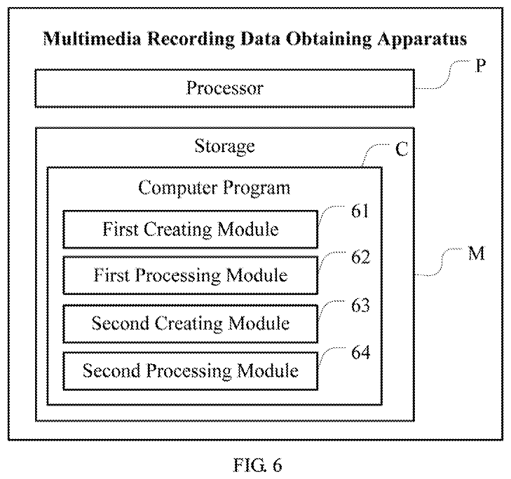

FIG. 1 is a flow chart of an embodiment of a multimedia recording data obtaining method according to present disclosure. In this embodiment, a multimedia recording method is provided. The method is a computer-implemented method executable for a processor, which may be implemented through a terminal device, for example, a multimedia recording apparatus as shown in FIG. 6 such as a portable electronic device (e.g., a mobile phone) or implemented through a storage medium, for example, a USB flash drive, a portable hard disk, a magnetic disk, an optical disk, a computer memory, a read-only memory (ROM), or a random access memory (RAM). The terminal device includes a multimedia recording device such as a microphone. As shown in FIG. 1, the method includes the following steps.

S101: creating a first service recording thread upon receiving a recording request of a first application program of the terminal device.

In this embodiment, the terminal device may be an electronic device capable of performing multimedia recording, for example, a mobile phone, a tablet computer, a computer, or the like. The operating system on the terminal device may be an operating system such as ANDROID, iOS, Linux, or Windows. The multimedia recording can be audio recording, video recording, audio and video recording, and the like. For convenience of explanation, the audio recording performed through a terminal device with ANDROID system is exemplified below, but it is not limited thereto.

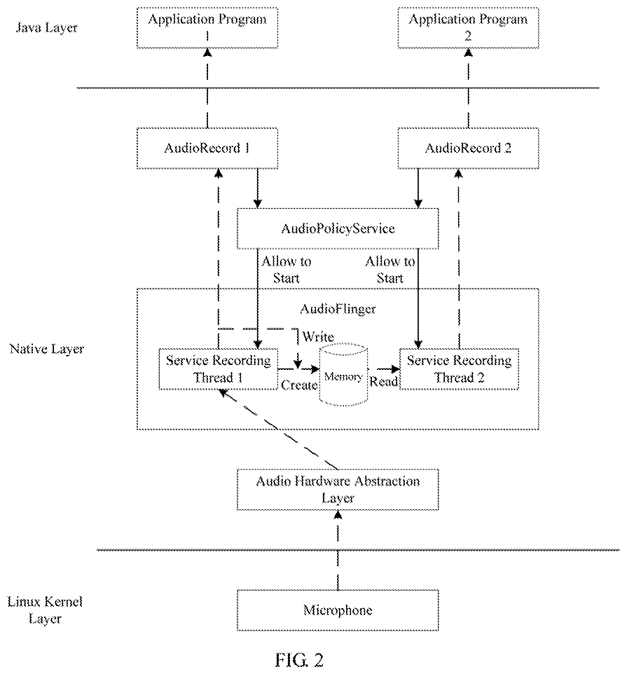

FIG. 2 is a schematic diagram of an example of an ANDROID system for implementing the multimedia recording data obtaining method of FIG. 1. As shown in FIG. 2, an ANDROID system for audio recording can be roughly divided into three layers during, namely a Java layer, a Native layer and a Linux kernel layer. In which, the Java layer is used to execute application programs; the Native layer is used for thread management; and the Linux kernel layer is used for hardware management. AudioRecord is a service of a application program of the Java layer in the Native layer; AudioFlinger and AudioPolicyService are services in the Native layer for realizing audio recording, where the AudioFlinger manages multiple service recording threads and is for processing the recorded data, and the AudioPolicyService is mainly used to control the start, the stop, and the release of service recording threads. Each AudioRecord corresponds to a service recording thread in the AudioFlinger. An Audio hardware abstraction layer is responsible for manipulating the hardware of the multimedia recording device. The solid lines in FIG. 2 indicate control flows, and the broken lines indicate data flows.

In this embodiment, after receiving the recording request of the first application program, the first service recording thread corresponding to the recording request is created. For example, after receiving an audio recording request of the first application program, the first service recording thread corresponding to the audio recording request is created.

S102: obtaining first multimedia data recorded by the multimedia recording device of the terminal device through the first service recording thread, returning the first multimedia data to the first application program, and storing the first multimedia data to a first storage space.

Taking the audio recording in FIG. 2 as an example, when the first application program performs an audio recording, the first service recording thread obtains first audio data of the audio recording from a microphone through the Audio hardware abstraction layer, and returns the first audio data to the first application program through the AudioRecord, and then stores the first audio data to the first storage space.

The first storage space is a new-created memory space in ANDROID native multimedia service, that is, the AudioRecord. In one embodiment, the capacity of the memory space is determined according to a format of multimedia data to be recorded by the first application program.

In this embodiment, a memory space may be created by the first service recording thread; or an existing memory space may be used as the storage space of the multimedia data. In which, information of the format of the multimedia data to be recorded includes but is not limited to one or more of a sampling rate, a sampling digit, and a number of channels.

Taking the audio recording in FIG. 2 as an example, the size of the memory space can be determined by the actual recording format of the first service recording thread in the Audio hardware abstraction layer. For instance, if the sampling rate is 44100 HZ, the sampling digit is 2 bytes, and the number of channels is 2, the size of the memory space (in bytes) is equal to the number of frames times the size of one frame of data, where (the size of one frame of data is equal to the sampling digit times the number of channels, that is, 2*2). Since the delay in the operation of the hardware of the microphone will affect the number of frames, official builds of ANDROID suggest the number of frames is 47.5 for the dual channel, 2 bytes sampling digit, and 44100 Hz recording data.

In addition, ANDROID has a standard interface of AudioRecord::getMinFrameCount(size_t* frameCount, uint32_t sampleRate, audio_format_t format, audio_channel_mask_t channelMask), which can be used to directly calculate the required number of frames frameCount and the size of the memory space for storing audio record data of different audio recording formats.

S103: creating a second service recording thread corresponding to a second application program of the terminal device if a recording request of the second application program is received when the first service recording thread is executing.

In this embodiment, if the first application program receives the recording request of the second application program when performing multimedia recording, it creates and starts the second service recording thread. Taking the audio recording in FIG. 2 as an example, after the second service recording thread is created, the AudioPolicyService requirements to allow the second service recording thread to start when the AudioFlinger has a service recording thread.

S104: obtaining, by the second application program, the first multimedia data from the first storage space through the second service recording thread.

In this embodiment, since the multimedia recording device is occupied by the first service recording thread, the second service recording thread does not obtain the multimedia data from the multimedia recording device, but obtains the first multimedia data from the first storage space, and returns the first multimedia data to the second application program, thereby enabling multiple application programs to simultaneously perform multimedia recording.

Taking the audio recording of FIG. 2 as an example, the second service recording thread does not obtain the recorded data from the Audio hardware abstraction layer, but reads the recorded data from the first storage space.

In this embodiment, the multimedia recording data obtaining method includes: creating a first service recording thread upon receiving a recording request of a first application program of the terminal device; obtaining first multimedia data recorded by the multimedia recording device of the terminal device through the first service recording thread, returning the first multimedia data to the first application program, and storing the first multimedia data to a first storage space; creating a second service recording thread corresponding to a second application program of the terminal device if a recording request of the second application program is received when the first service recording thread is executing; and obtaining, by the second application program, the first multimedia data from the first storage space through the second service recording thread, and returning the first multimedia data to the second application program. In this manner, multiple application programs are enabled to perform multimedia recording simultaneously. In this embodiment, by allowing the creation of the second service recording thread of the second application program and obtaining, by the second application program, the first multimedia data from the first storage space through the second service recording thread, other application programs are allowed to obtain the multimedia data to perform multimedia recording simultaneously while one application program performs multimedia recording, which can meet the requirements of performing multimedia recording simultaneously through multiple application programs, thereby enhancing the user experience.

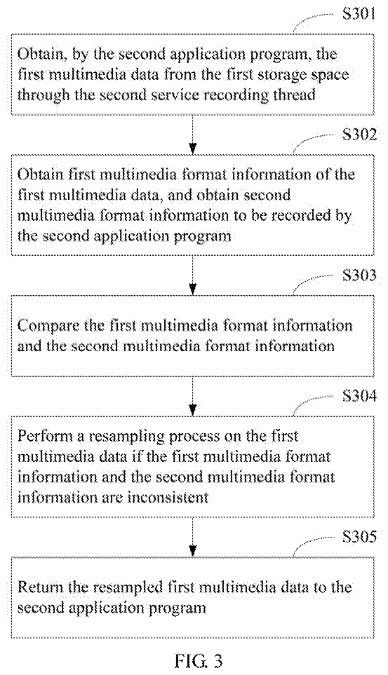

FIG. 3 is a flow chart of performing a resampling process on the first multimedia data in the multimedia recording data obtaining method of FIG. 1. As shown in FIG. 3, step S104 of the multimedia recording data obtaining method of FIG. 1 may include the following steps.

S301: obtaining, by the second application program, the first multimedia data from the first storage space through the second service recording thread.

S302: obtaining first multimedia format information of the first multimedia data, and obtaining second multimedia format information to be recorded by the second application program.

In this embodiment, the multimedia format information may include, but is not limited to one or more of a sampling rate, a sampling digit, and a number of channels. The obtained first multimedia format information of the first multimedia data may be determined by obtaining a multimedia format required by the first application program, or may be determined by a format of the first multimedia data in the first storage space.

In one embodiment, step S102 may include:

storing the first multimedia data to the first storage space, and recording the first multimedia format information of the first multimedia data.

Step S302 may include:

obtaining the recorded first multimedia format information.

In this embodiment, the first multimedia format information may be recorded in the form of member variables. Taking the audio recording in FIG. 2 as an example, when the AudioFlinger service creates the first service recording thread, it will create a memory space for the AudioFlinger service and record the audio format (e.g., a sampling rate, a sampling digit, and a number of channels) of the first service recording thread to perform recording in the Audio hardware abstraction layer in three member variables. The recorded first multimedia format information can be obtained by reading the member variables. Specifically, it can be realized in several ways as follows.

Method one: creating four member variables in the AudioFlinger directly to record the memory address, the sampling rate, the sampling digit, and the number of channels; and configuring two methods (a memory write method and a memory read method) for respectively writing and reading the data in memory for the service recording thread to use.

Method two: creating a new class to encapsulate the four member variables and the two methods of method one. This method can first create an object of the class in the AudioFlinegr, then create the memory space of the object, and finally record the audio format of the first service recording thread to perform recording in the Audio hardware abstraction layer to the three related member variables of the object.

Method three: implementing through the native multimedia library “libnbaio.so” of ANDROID.

S303: comparing the first multimedia format information and the second multimedia format information.

S304: performing a resampling process on the first multimedia data if the first multimedia format information and the second multimedia format information are inconsistent.

In this embodiment, since the multimedia formats for different application programs may be different, it may be determined by comparing the first multimedia format information with the second multimedia format information. If the first multimedia format information and the second multimedia format information are consistent, it indicates that the multimedia format for the second application program is the same as the multimedia format for the first application program, hence the first multimedia data in the first storage space may be directly returned to the second application program; if the first multimedia format information and the second multimedia format information are inconsistent (e.g., the first multimedia format information and the second multimedia format information are not the same), it indicates that the multimedia format for the second application program and the multimedia format for the first application program are different, and the second application program cannot use the first multimedia data in the first storage space directly, hence the first multimedia data has to be resampled.

In which, the resampling process may include data processing such as converting the number of channels and the sampling digit. The resampling process can be implemented by calling the standard interface of ANDROID, or by configuring a resampling handler module. For example, the data with the sampling rate of 44100 Hz can be resampled to obtain the data with the sampling rate of 48000 Hz.

S305: returning the resampled first multimedia data to the second application program.

In this embodiment, the first multimedia data is resampled in the case that the first multimedia format information and the second multimedia format information are inconsistent, so that the resampled first multimedia data meets the requirement of the second application program, thereby enabling multiple application programs to simultaneously perform multimedia recording.

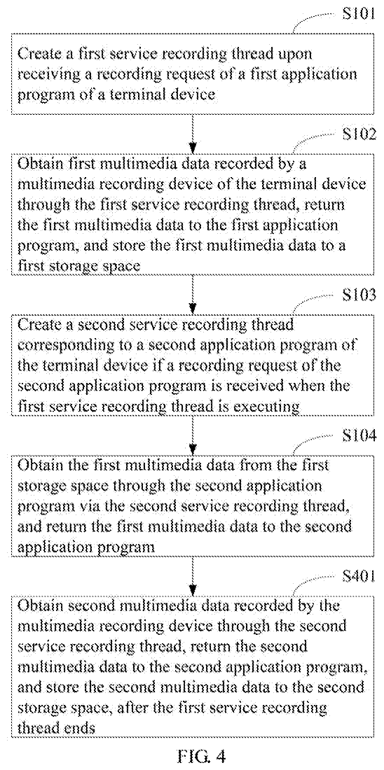

FIG. 4 is a flow chart of another embodiment of a multimedia recording data obtaining method according to present disclosure. The multimedia recording method is based on the multimedia recording method of FIG. 1. As shown in FIG. 4, after step S104, the method further includes the following steps.

S401: obtaining second multimedia data recorded by the multimedia recording device through the second service recording thread, returning the second multimedia data to the second application program, and storing the second multimedia data to the second storage space, after the first service recording thread terminates.

In this embodiment, the first application program and the second application program simultaneously perform multimedia recording. If the first application program stops the multimedia recording, the data in the first storage space will not be updated, and the second application program can not read the multimedia data from the first storage space. Since only the second application program performs multimedia recording at this time, the second service recording thread can obtain the second multimedia audio data recorded by the multimedia recording device after the first service recording thread terminates, and the second multimedia data is returned to the second application program and stored in the second storage space. If there is a third application program to perform multimedia recording later, the multimedia data can be obtained from the second storage space.

In which, the terminate of the first service recording thread may be, for example, the stop or the release of the thread. The format of the second multimedia data is the format for the second application program to record. The second storage space may be the same storage space as the first storage space, or may be a storage space recreated by the second service recording thread, which is not limited herein.

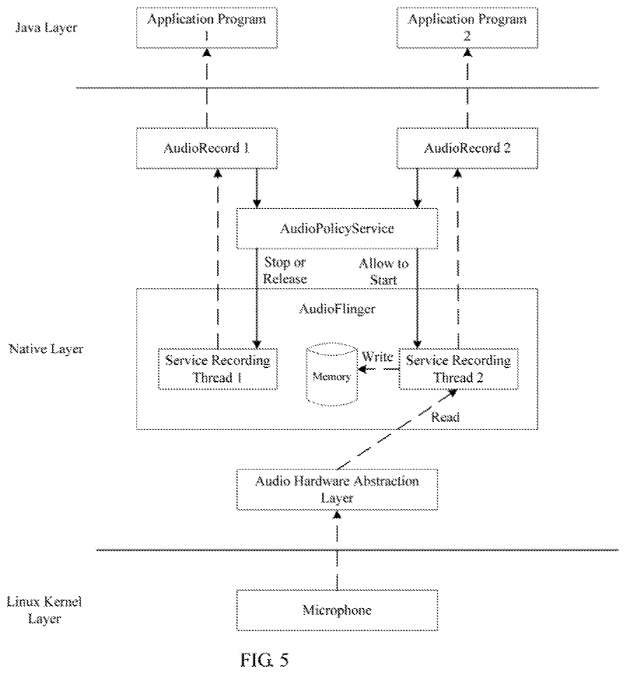

FIG. 5 is a schematic diagram of an example of an ANDROID system for implementing the multimedia recording data obtaining method of FIG. 4. As shown in FIG. 1, taking the audio recording in FIG. 5 as an example, if the first application program stops or releases the recording, the data in the memory space of the AudioFlinge will not be updated, and the second application program may not read the recorded data. Therefore, after the second service recording thread finds out that the first server recording thread is stopped or released, it will not read the recorded data from the memory space of the AudioFlinger, but from the original channel of the ANDROID system. The recorded data will be read from the Audio hardware abstraction layer, and the recorded data read from the Audio hardware abstraction layer is written into the memory space of the AudioFlinger.

In this embodiment, after the first service recording thread is stopped or released, the second service recording thread obtains the multimedia data directly from the multimedia recording device, which can ensure that the second application program can continue the multimedia recording without the affection of the first application program. In addition, by storing the multimedia data to the second storage space, after that other application programs can simultaneously perform multimedia recording.

In one embodiment, before step S401, the method may further include:

receiving a terminate message transmitted by the first service recording thread;

or further include;

recording an amount of the data obtained from the first storage space through the second service recording thread in each time; and

determining the first service recording thread being terminated if a number of times of the amount of the data obtained from the first storage space through the second service recording thread being zero is larger than a preset times threshold.

In this embodiment, the terminate message that the first application program is stopped or released can be obtained in two ways as follows.

Method one: transmitting the terminate message to the second service recording thread through the first service recording thread before it terminates, and receiving the terminate message transmitted by the first service recording thread through the second service recording thread.

Method two: recording the amount of the multimedia data obtained from the first storage space through the second service recording thread in each time; and determining the first service recording thread being terminated if a number of times of the amount of the data obtained from the first storage space through the second service recording thread being zero is lager than a preset times threshold which indicates that the multimedia data in the first storage space is not updated.

Taking the audio recording in FIG. 5 as an example, the first service recording thread 1 notifies the second service recording thread 2 that it is about to stop or release through the AudioFlinger service; or the second service recording thread reads the recorded data from the memory after the first service recording thread stops or releases, and determining that the first service recording thread is stopped or released if all the amount of the data is 0 after the second service recording thread reads for n times (n>=1).

In this embodiment, by the method of storing the multimedia data of one application program into a memory space (i.e., a buffer) and then obtaining the multimedia data from the memory space through another application, the plurality of application programs which record with different multimedia formats (e.g., the sampling rate, the sampling digit, and the number of channels) can simultaneously perform multimedia recording. After each application obtains the multimedia data, it can use the data to simultaneously perform different functions and operations, which helps to improve the interactive capability of the system.

In this embodiment, the improvements are mainly on the Native layer of the system, which do not involve the Java layer, only need to modify the existing framework of the system, do not add additional overhead, and do not increase the time of multimedia recording. Therefore, the function of simultaneous multimedia recording can be realized without modifying any interface and code of the application program, which guarantees the compatibility with the Java layer. The multimedia recording can be simultaneously performed by multiple application programs in a simple and fast manner without modifying the system framework, modifying the codes of the application program, or increasing the multimedia recording time.

In this embodiment, the multimedia recording data obtaining method includes: creating a first service recording thread upon receiving a recording request of a first application program of the terminal device; obtaining first multimedia data recorded by the multimedia recording device of the terminal device through the first service recording thread, returning the first multimedia data to the first application program, and storing the first multimedia data to a first storage space; creating a second service recording thread corresponding to a second application program of the terminal device if a recording request of the second application program is received when the first service recording thread is executing; and obtaining, by the second application program, the first multimedia data from the first storage space through the second service recording thread, and returning the first multimedia data to the second application program. In this manner, multiple application programs are enabled to perform multimedia recording simultaneously. In this embodiment, by allowing the creation of the second service recording thread of the second application program and obtaining, by the second application program, the first multimedia data from the first storage space through the second service recording thread, other application programs are allowed to obtain the multimedia data to perform multimedia recording simultaneously while one application program performs multimedia recording, which can meet the requirements of performing multimedia recording simultaneously through multiple application programs, thereby enhancing the user experience.

It should be understood that, the sequence of the serial number of the steps in the above-mentioned embodiments does not mean the execution order while the execution order of each process should be determined by its function and internal logic, which should not be taken as any limitation to the implementation process of the embodiments.

FIG. 6 is a schematic block diagram of a multimedia recording data obtaining apparatus according to an embodiment of present disclosure. Corresponding to the multimedia recording data obtaining method described in the foregoing embodiments, a multimedia recording data obtaining apparatus is provided. For the convenience of explanation, only the parts related to this embodiment are shown. In this embodiment, the apparatus may be, for example, a portable electronic such as a mobile phone.

As shown in FIG. 6, the apparatus includes a storage M, a processor P. The storage M, for example, a hard disk and/or a memory, is configured to store a computer program C executed by the processor P and intermediate data generated when the computer program is executed. The computer program C includes a first creating module 61, a first processing module 62, a second creating module 63, and a second processing module 64.

The first creating module 61 is configured to create a first service recording thread upon receiving a recording request of a first application program of the multimedia recording apparatus.

The first processing module 62 is configured to obtain first multimedia data recorded by the multimedia recording device of the multimedia recording apparatus through the first service recording thread, return the first multimedia data to the first application program, and store the first multimedia data to a first storage space.

The second creating module 63 is configured to create a second service recording thread corresponding to a second application program of the multimedia recording apparatus if a recording request of the second application program is received when the first service recording thread is executing.

The second processing module 64 is configured to obtain, by the second application program, the first multimedia data from the first storage space through the second service recording thread, and return the first multimedia data to the second application program.

In one embodiment, the first storage space is a memory space, and the capacity of the memory space is determined according to a format of the multimedia data to be recorded by the first application program.

In one embodiment, the second processing module 64 is configured to:

obtain, by the second application program, the first multimedia data from the first storage space through the second service recording thread;

obtain first multimedia format information of the first multimedia data, and obtain second multimedia format information to be recorded by the second application program;

compare the first multimedia format information and the second multimedia format information;

perform a resampling process on the first multimedia data if the first multimedia format information and the second multimedia format information are inconsistent; and

return the resampled first multimedia data to the second application program.

In one embodiment, the first processing module 62 is configured to:

store the first multimedia data to the first storage space, and recording the first multimedia format information of the first multimedia data.

In one embodiment he second processing module 64 is configured to:

obtain the recorded first multimedia format information.

In one embodiment, the apparatus may further include a third processing module. The third processing module is configured to:

obtain second multimedia data recorded by the multimedia recording device through the second service recording thread, return the second multimedia data to the second application program, and store the second multimedia data to the second storage space, after the first service recording thread terminates.

In one embodiment, the third processing module is further configured to:

receive a terminate message transmitted by the first service recording thread;

or further configured to:

record an amount of the data obtained from the first storage space through the second service recording thread in each time; and

determine the first service recording thread being terminated if a number of times of the amount of the data obtained from the first storage space through the second service recording thread being zero is lager than a preset times threshold.

In one embodiment, the first multimedia data includes audio data or video data. In other embodiments, the first multimedia data may include both audio data and video data.

In this embodiment, each of the above-mentioned modules/units is implemented in the form of software (i.e., the computer program C). In other embodiments, each of the above-mentioned modules/units may be implemented in the form of hardware (e.g., a circuit of the multimedia recording data obtaining apparatus which is coupled to the processor P) or a combination of hardware and software (e.g., a circuit with a single chip microcomputer).

In this embodiment, the multimedia recording data obtaining apparatus implements: creating a first service recording thread upon receiving a recording request of a first application program of the multimedia recording apparatus; obtaining first multimedia data recorded by the multimedia recording device of the multimedia recording apparatus through the first service recording thread, returning the first multimedia data to the first application program, and storing the first multimedia data to a first storage space; creating a second service recording thread corresponding to a second application program of the multimedia recording apparatus if a recording request of the second application program is received when the first service recording thread is executing; and obtaining, by the second application program, the first multimedia data from the first storage space through the second service recording thread, and returning the first multimedia data to the second application program. In this manner, multiple application programs are enabled to perform multimedia recording simultaneously. In this embodiment, by allowing the creation of the second service recording thread of the second application program and obtaining, by the second application program, the first multimedia data from the first storage space through the second service recording thread, other application programs are allowed to obtain the multimedia data to perform multimedia recording simultaneously while one application program performs multimedia recording, which can meet the requirements of performing multimedia recording simultaneously through multiple application programs, thereby enhancing the user experience.

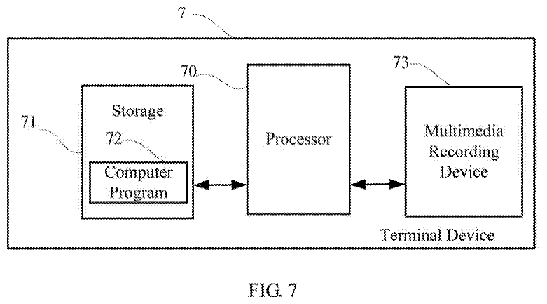

FIG. 7 is a schematic diagram of a terminal device according to an embodiment of the present disclosure. As shown in FIG. 7, the terminal device 7 of this embodiment includes a processor 70, a memory 71, a computer program 72 such as a program which is stored in the memory 71 and executable on the processor 70, and a multimedia recording device 73. When executing (instructions in) the computer program 72, the processor 70 implements the steps in the above-mentioned embodiments of the method, for example, steps S101-S104 shown in FIG. 1. Alternatively, when the processor 70 executes the (instructions in) computer program 72, the functions of each module/unit in the above-mentioned device embodiments, for example, the functions of the modules 61-64 shown in FIG. 6 are implemented.

Exemplarily, the computer program 72 may be divided into one or more modules/units, and the one or more modules/units are stored in the storage 61 and executed by the processor 70 to realize the present disclosure. The one or more modules/units may be a series of computer program instruction sections capable of performing a specific function, and the instruction sections are for describing the execution process of the computer program 72 in the terminal device 7. For example, computer program 72 can be divided into a first creating module, a first processing module, a second creating module, and a second processing module:

the first creating module is configured to create a first service recording thread upon receiving a recording request of a first application program of the terminal device 7;

the first processing module is configured to obtain first multimedia data recorded by a the multimedia recording device of the terminal device 7 through the first service recording thread, return the first multimedia data to the first application program, and store the first multimedia data to a first storage space;

the second creating module is configured to create a second service recording thread corresponding to a second application program of the terminal device 7 if a recording request of the second application program is received when the first service recording thread is executing; and

the second processing module is configured to obtain, by the second application program, the first multimedia data from the first storage space through the second service recording thread, and return the first multimedia data to the second application program.

The terminal device 7 may be a portable device such as a mobile phone. The terminal device 7 may include, but is not limited to, a processor 70 and a storage 61. It can be understood by those skilled in the art that FIG. 7 is merely an example of the terminal device 7 and does not constitute a limitation on the terminal device 7, and may include more or fewer components than those shown in the figure, or a combination of some components or different components. For example, the terminal device 7 may further include an input/output device, a network access device, a bus, a display, and the like.

The processor 70 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 61 may be an internal storage unit of the terminal device 7, for example, a hard disk or a memory of the terminal device 7. The storage 61 may also be an external storage device of the terminal device 7, for example, a plug-in hard disk, a smart media card (SMC), a secure digital (SD) card, flash card, and the like, which is equipped on the terminal device 7. Furthermore, the storage 61 may further include both an internal storage unit and an external storage device, of the terminal device 7. The storage 61 is configured to store the computer program 72 and other programs and data required by the terminal device 7. The storage 61 may also be used to temporarily store data that has been or will be output.

Those skilled in the art may clearly understand that, for the convenience and simplicity of description, the division of the above-mentioned functional units and modules is merely an example for illustration. In actual application programs, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus/terminal device and method may be implemented in other manners. For example, the above-mentioned apparatus/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual requirements to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented multimedia recording data obtaining method for a terminal device having a multimedia recording device, comprising executing on a processor of the terminal device the steps of:
creating a first service recording thread upon receiving a recording request of a first application program of the terminal device;
obtaining first multimedia data recorded by the multimedia recording device of the terminal device through the first service recording thread, returning the first multimedia data to the first application program, and storing the first multimedia data to a first storage space;
creating a second service recording thread corresponding to a second application program of the terminal device in response to a recording request of the second application program being received when the first service recording thread is executing; and
obtaining, by the second application program, the first multimedia data from the first storage space through the second service recording thread.

2. The method of claim 1, wherein the first storage space is a memory space, and the capacity of the memory space is determined according to a format of multimedia data to be recorded by the first application program.

3. The method of claim 1, wherein the step of obtaining, by the second application program, the first multimedia data from the first storage space through the second service recording thread comprises:
obtaining, by the second application program, the first multimedia data from the first storage space through the second service recording thread;
obtaining first multimedia format information of the first multimedia data, and obtaining second multimedia format information to be recorded by the second application program;
comparing the first multimedia format information and the second multimedia format information;
performing a resampling process on the first multimedia data in response to the first multimedia format information and the second multimedia format information being inconsistent; and
returning the resampled first multimedia data to the second application program.

4. The method of claim 3, wherein the step of storing the first multimedia data to a first storage space comprises:
storing the first multimedia data to the first storage space, and recording the first multimedia format information of the first multimedia data;
the step of obtaining the first multimedia format information of the first multimedia data comprises:
obtaining the recorded first multimedia format information.

5. The method of claim 1, further comprising:
obtaining second multimedia data recorded by the multimedia recording device through the second service recording thread, returning the second multimedia data to the second application program, and storing the second multimedia data to the second storage space, after the first service recording thread terminates.

6. The method of claim 5, before the step of obtaining the second multimedia data recorded by the multimedia recording device through the second service recording thread further comprising:
receiving a terminate message transmitted by the first service recording thread;
or further comprising:
recording an amount of the data obtained from the first storage space through the second service recording thread in each time; and
determining the first service recording thread being terminated in response to a number of times of the amount of the data obtained from the first storage space through the second service recording thread being zero being lager than a preset times threshold.

7. The method of claim 1, wherein the first multimedia data comprises at least one of audio data and video data.

8. A multimedia recording data obtaining apparatus, comprising:
a multimedia recording device;
a first creating module configured to create a first service recording thread upon receiving a recording request of a first application program of the multimedia recording apparatus;
a first processing module configured to obtain first multimedia data recorded by the multimedia recording device of the multimedia recording apparatus through the first service recording thread, return the first multimedia data to the first application program, and store the first multimedia data to a first storage space;
a second creating module configured to create a second service recording thread corresponding to a second application program of the multimedia recording apparatus in response to a recording request of the second application program being received when the first service recording thread is executing; and
a second processing module configured to obtain, by the second application program, the first multimedia data from the first storage space through the second service recording thread.

9. The apparatus of claim 8, wherein the first storage space is a memory space, and the capacity of the memory space is determined according to a format of multimedia data to be recorded by the first application program.

10. The apparatus of claim 8, wherein the second processing module is configured to:
obtain, by the second application program, the first multimedia data from the first storage space through the second service recording thread;
obtain first multimedia format information of the first multimedia data, and obtain second multimedia format information to be recorded by the second application program;
compare the first multimedia format information and the second multimedia format information;
perform a resampling process on the first multimedia data in response to the first multimedia format information and the second multimedia format information being inconsistent; and
return the resampled first multimedia data to the second application program.

11. The apparatus of claim 10, wherein the first processing module is configured to:
store the first multimedia data to the first storage space, and record the first multimedia format information of the first multimedia data;
the second processing module is configured to:
obtain the recorded first multimedia format information.

12. The apparatus of claim 8, further comprising a third processing module configured to:
obtain second multimedia data recorded by the multimedia recording device through the second service recording thread, return the second multimedia data to the second application program, and store the second multimedia data to the second storage space, after the first service recording thread terminates.

13. The apparatus of claim 12, wherein the third processing module is further configured to:
receive a terminate message transmitted by the first service recording thread;
or further configured to:
record an amount of the data obtained from the first storage space through the second service recording thread in each time; and
determine the first service recording thread being terminated in response to a number of times of the amount of the data obtained from the first storage space through the second service recording thread being zero being lager than a preset times threshold.

14. The apparatus of claim 8, wherein the first multimedia data comprises at least one of audio data and video data.

15. A terminal device, comprising:
a multimedia recording device;
a memory;
a processor; and
one or more computer programs stored in the memory and executable on the processor, wherein the one or more computer programs comprise:
instructions for creating a first service recording thread upon receiving a recording request of a first application program of the terminal device;
instructions for obtaining first multimedia data recorded by the multimedia recording device of the terminal device through the first service recording thread, returning the first multimedia data to the first application program, and storing the first multimedia data to a first storage space;
instructions for creating a second service recording thread corresponding to a second application program of the terminal device in response to a recording request of the second application program being received when the first service recording thread is executing; and
instructions for obtaining, by the second application program, the first multimedia data from the first storage space through the second service recording thread.

16. The terminal device of claim 15, wherein the first storage space is a memory space, and the capacity of the memory space is determined according to a format of multimedia data to be recorded by the first application program.

17. The terminal device of claim 15, wherein the instructions for obtaining, by the second application program, the first multimedia data from the first storage space through the second service recording thread comprise:
instructions for obtaining, by the second application program, the first multimedia data from the first storage space through the second service recording thread;
instructions for obtaining first multimedia format information of the first multimedia data, and obtaining second multimedia format information to be recorded by the second application program;
instructions for comparing the first multimedia format information and the second multimedia format information;
instructions for performing a resampling process on the first multimedia data in response to the first multimedia format information and the second multimedia format information being inconsistent; and
instructions for returning the resampled first multimedia data to the second application program.

18. The terminal device of claim 17, wherein the instructions for storing the first multimedia data to a first storage space comprise:
instructions for storing the first multimedia data to the first storage space, and recording the first multimedia format information of the first multimedia data;
the instructions for obtaining the first multimedia format information of the first multimedia data comprise:
instructions for obtaining the recorded first multimedia format information.

19. The terminal device of claim 15, wherein the one or more computer programs further comprise:
instructions for obtaining second multimedia data recorded by the multimedia recording device through the second service recording thread, returning the second multimedia data to the second application program, and storing the second multimedia data to the second storage space, after the first service recording thread terminates.

20. The terminal device of claim 19, wherein the one or more computer programs further comprise:
instructions for receiving a terminate message transmitted by the first service recording thread;
or further comprise:
instructions for recording an amount of the data obtained from the first storage space through the second service recording thread in each time; and
instructions for determining the first service recording thread being terminated in response to a number of times of the amount of the data obtained from the first storage space through the second service recording thread being zero being lager than a preset times threshold.
